(19) United States
(12) Patent Application Publication
(10) Pub. No.: US 2013/0272792 A1
(43) Pub. Date: Oct. 17, 2013

(54) Process and Apparatus for Sealing Wellhead Leaks Underwater or On Land

(71) Applicant: Steve Cordell, Vancouver, WA (US)

(72) Inventor: Steve Cordell, Vancouver, WA (US)

(21) Appl. No.: 13/868,060

(22) Filed: Apr. 22, 2013

(51) Int. Cl. B67D 99/00

(52) U.S. Cl. CPC B67D 99/00
USPC 405/52

(57) ABSTRACT

The sealing of underwater and above ground leaks of materials such as petroleum, mud, gas and finely divided solids from wellheads, pipelines and other natural or man-made works is accomplished by placing over the leak a heaviest duty, leak-proof, weighted curtain whose shape and size allow the curtain to be filled in place with cement or other heavy materials, thus effectively sealing the outflow of the materials.

The curtain can optionally be fitted with one or more redirection valves to drain off and capture the materials under pressure, for example to transport oil, during and even after the sealing process, from a seabed wellhead leak to a surface ship. An optional second, larger curtain fitted with through-channels with stopcocks can be placed over the first curtain, and the lower valves and through-channels can be connected to continue the transport of materials.

Preparation of the sealing sight is minimal, ideally consisting of forming a continuous circular path to more carefully mate the curtain's peripheral-weights with the ground or seabed terrain. If a wellpipe or other obstacle might damage the curtain, or vice versa, the wellpipe would be modified, and/or an optional self-expanding support attached to the curtain underside can protect the curtain during its cement-filling weighting process.

### FIELD OF THE INVENTION

The and apparatus off intended or unintended leaks, gushers and flows of gas, mud, petroleum, other fluids and finely divided solids on land, on the seabed, or near land or the seabed, whereby the sealing apparatus may redirect the flow of fluid or gas to pipes, tanks or other holding or transporting means or vessels.

### BACKGROUND OF THE PRIOR ART

This did not function on the British Petroleum leak, and over time the conventional method of sealing with a cap on the pipe protruding from the well did function. During the many unsuccessful trials, weeks went by and the leaking petroleum continued to spill out into the sea.

Method and apparatus for sealing underwater fluid spills, & redirects fluid to ships. Sealing spills in the past (e.g. BP in Gulf) was by pouring fast-setting cement on the spill. For BP the cement dispersed! Invention uses cement indirectly and securely over impervious, weighted curtain.

### SUMMARY AND OBJECTS OF THE INVENTION

Summary of the Apparatus and Method: The sealing apparatus is best described as a curtain, composed of layers of the strongest materials available and heavily weighted on its circumference. The curtain can be laid on or over the leak in one layer or successive layers. The method consists of optionally roughly preparing the base of the seabed, or the ground if the leak is on land, to give the sealing curtain a good base for laying it over the leak. The first curtain is laid over the leak, and then in stages, cement is poured inside of the weighted circumference. This method allows for the curtain to be weighted down with cement with none or very little of it being blown away by the forces of liquid or gas exiting the leak (FIG. 2). In the simplest method, the leaking fluid or gas will cause part of the curtain to flutter no matter how heavy the original weighting is. The flutter can be mostly eliminated by installing redirect mechanisms on the curtain. In this manner, fluid or gas under pressure will be allowed to escape or to be redirected via pipes, tubes or other means. This takes pressure off the curtain and the weighting will thus be simplified.

Description of the Apparatus using the British Petroleum (BP) Gulf of Mexico oil spill example: The curtain will be used to create a firm but flexible base on which to dump cement into the wellhead area. The device has the form and some other characteristics of the contraceptive diaphragm. The diaphragm was designed to keep sperm out, but the curtain will keep the oil or gas within the area and will stop almost all of the leakage. Depending on the spill volume and pressure, the curtain can be designed to accept venting tube-connections that are valves that can reroute almost all of the oil or gas leaking underwater to the surface via multiple pipes or flexible tubes. If these valve connectors are used on the first curtain, then the second and subsequent curtains will require through-channels with stopcocks for each connection; auto-connects between curtains are foreseen for this purpose, and would be easier to attach underwater.

Description of the Method using the BP oil spill example for both underwater and land leaks: A thick, flexible and impervious shaped curtain, heavily weighted around the edge, will be placed over the spewing wellhead, pipe or pipeline. Cement is poured inside a lip created by the weights on the complete circumference of the curtain. Initially, only about ¾ of the circumference would be filled with cement, allowing oil or gas to continue exiting the curtain unimpeded. Curtain portions weighted with lead but un-weighted with cement may flutter roughly. Even before the concrete is set, the final quarter of the curtain will be slowly filled. When the oil exiting that quarter begins to diminish, as measured outside of the curtain visually or by instruments, the curtain's existing cement donut may now be further weighted with cement, without overstressing the central part directly over the pipe or wellhead (this pipe existed at the wellhead in the BP example, and with this instant curtain method would have been trimmed). A self-expanding framework will be placed near the wellpipe if the wellpipe would be damaged or if it might damage the curtain material (Ref. 1). Now it is time to very slowly weight with cement the remaining sector of the curtain as well as some or all of the curtain's surface.

When completely weighted and almost sealed, a second but larger curtain may be placed over the site. A self-expanding framework is attached to the second curtain to prevent a heavy cement deposit from damaging the first curtain's central area. Cement can now carefully be placed over the second curtain and its environs. Obviously, cement can later be laid according to experience to even keep light seepage from occurring. See below under ‘Preparation for laying the curtains’ for ideal preparation of the seabed with respect to a good ground fit.

Construction of the curtain: A layered curtain, having exceptional strength and preferably with a round shape, is used for the invention (FIG. 1B). If required because of surface anomalies, other shapes may be used. This curtain might have as its foundation the highest strength Kevlar-web and titanium cable-web, and integrated with external layers of Neoprene-type sheeting to form a sandwich (FIG. 1A). The Neoprene is securely attached to the upper and lower layers of the Kevlar sandwich. The type of Kevlar must be chosen to be salt-water protective for several hours, and there are now even stronger materials than Kevlar that are less reactive to seawater. The lower Neoprene layer is reinforced with additional titanium cable-webbing to prevent puncture and tears if the well-pipe or large seabed elements have sharp projections. The edges of the circular sandwich are weighted with very large, heavy lead weights in the form of round sandbags. These sandbag forms may be constructed by cutting sections from an oversized curtain and rolling them up with the lead weights to create the required size curtain with exceptional weight (FIGS. 1A & 1B). Since lead is cheap, available everywhere, heavy, and has a low melting point for casting, it is the preferred but not the only weighting material that would be acceptable. In addition, some of the lead weights could be recovered. The weighted lips on the curtain circumference will weigh down the edge and they will catch the cement that is poured around the circumference (Ref. 3).

It is understood that common materials used everywhere will be used; heavy duty nylon weave might be used to wrap up the peripheral weights, heat-welding, sewing, riveting will be used for connecting flanges, etc.

There are two radial reinforcements that may be required to ensure that the curtain remains circular at the weighted lip, and that the complete curtain surface remains robust. The first is a set of flexible, spring-loaded bars that allow the somewhat folded curtain to sink more rapidly from the water surface and to keep it circular over the well pipe. It is opened before the seabed is reached. For land applications, it will aid in transporting the weighted curtain to its destination wellhead and when placing the curtain near or within a drilling rig (Ref. 1) The second curtain includes a web of steel cables that will ensure that the curtain has even more strength than the materials described above (Ref. 2). The cables might be used for quick adjustment of the rim to be somewhat out-of-round if the seabed or land conditions require it. Both of the reinforcement apparatus are “heavy-duty”, otherwise they would be considered ubiquitous and require no further description here.

For lifting of the curtain, a standard, deep-throated hook is attached to the center of the curtain by using heavy-duty upper and lower flanges in the standard or usual manner (FIGS. 1A & 1B).

Preparation for laying the curtains: A manned or remote vehicle creates a relatively flat ring around the leak on which to place the curtain's weighted edge. This is obviously quite imprecise, but the more level, flatter, bulge-free the ring, the better will be the seal. This step can be repeated for a second or subsequent rings. To prepare either ring that might be too uneven, semi-automatic interlocking steel plates, similar to those used in WWII for instant runways, might be laid on selected parts of the ring (FIG. 2).

### OBJECT OF THE INVENTION

It is therefore the object of the invention to provide a process and apparatus to seal any underwater or land spill or gusher, whether the spill or gusher was intended or unintended, and independent of the type of exiting fluid, mud, gas or any other type of escaping material. The foregoing objects are achieved with the instant invention, which provides for the handling of underwater or on-land escaping material, no matter what its physical state of being sealed, or if redirection of some or all of the material is in process. Redirection is a part of the invention, but temporarily functioning as a holding vessel, or other standard ecological processes are not claimed.

The invention provides for a rapid solution for sealing spills, since all materials used for the construction of the curtain are readily available, and all of the individual materials can be stored for years until use. Even though the finished curtain is extremely heavy, any of the world's heavy-duty aircraft can transport together a small curtain and all elements for a large curtain to any port nearby a spill. The large curtain can be erected and prepared for transport to the local spill site within two days if a medium-sized crane is available.

### BRIEF DESCRIPTION OF THE DRAWINGS

FIG. 1: A) Side (horizontal) view is a slice through the curtain center showing the prepared curtain before it is raised from a preparation staging area by a crane. The three layers shown, Neoprene, Kevlar and titanium, are explained and described here but are not described in the Detailed Description in detail. The cross-sectional view shows only a slice through the center of the curtain. The lifting hook and its supporting flanges are shown. The figure shows a combination of layers and their positioning that the inventor determined would help describe the invention and might be ideal in the real world of spills. The three layers from bottom up are: Neoprene with titanium and Kevlar cable web, Kevlar web and titanium cable web, thick Neoprene alone as a good seal for cement. B) Top view of the same curtain showing the sections of the circumference with the rolled weights. The standard lifting hook and its supporting flanges are shown.

FIG. 2: Cross-section of the first curtain placed on its prepared underwater base ring showing the ring, the cement-catching lips, and the base ring for a possible second curtain. Also shown is one of the possible multiple redirecting valve connectors (valve shown in plugged or closed state, before attaching relief pipe or tube to protect the valve from sprayed cement).

### DETAILED DESCRIPTION

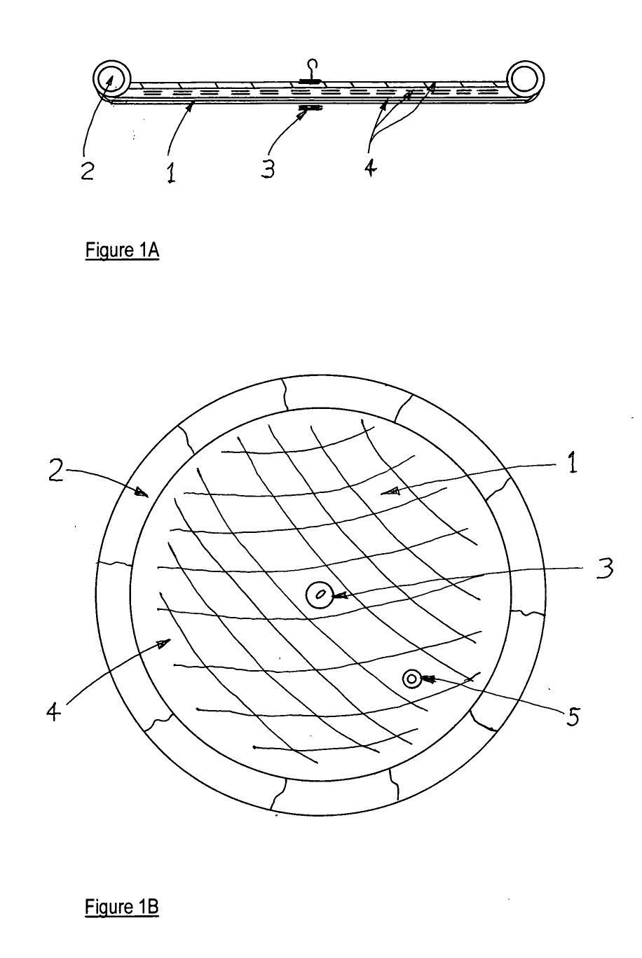

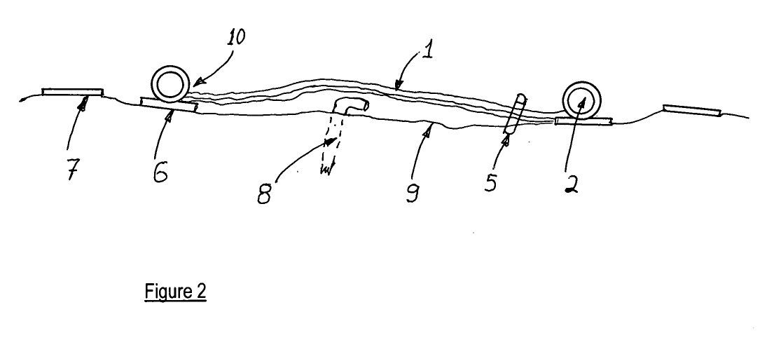

FIGS. 1A and 1B are two views of the apparatus and they are scaled alike; the numbers indicate the exact elements. The curtain 1 is integral with the peripheral weights 2. In FIG. 1B, the sections of weights 2 are clearly shown as separate weights and they are rolled up into the shown position on the periphery by using extra material when the curtain is laid out as a circle and its peripheral few feet are sliced for this purpose. No heavy duty rapping cables or webbing are shown on the round weights. The three layers 4 shown in FIG. 1A are indicated by three arrows and are only an example of one possible sandwich of curtain layers; in the FIG. 1B top view, the layers cannot be drawn but is also indicated as 4. The carrying hook 3 is shown with its connection flanges in both views. Only one redirection valve 5 is shown in FIG. 1B, and it is also shown in FIG. 2 as being capped on both ends to keep cement and other debris from entering the top connection section.

FIG. 2 is an example of the curtain over an underwater leak. It is a view of a slice through the curtain 1 but also shows one of the possible multiple redirection valves 5 and the wellpipe 8 (simulating the British Petroleum spill in the Gulf of Mexico). The pipe 8 is idealized in the drawing and will usually be an unknown until it is investigated and modified as required. In the FIG. 2 drawing, the curtain is in place on the seabed 9 and on the ring 6 on which the weighted periphery 2 has been positioned. Ring 7 is an optional path that has been created for a second curtain that is not yet in place.

Perhaps the most important element in the invention is shown clearly in FIG. 2 as the lip 10 of the weight-circle and its connection to the curtain 1. It is this part of the curtain that will catch the initial loads of cement and create weighted sections of the curtain to bolster the peripheral weights 2.

### REFERENCES

1. Example of radial spring-loaded bars used in a patent to protect a submarine from an enemy submarine-launched mine. German Patent P 39 20 187.2 “Seemine” (Underwater Mine) granted to Steve Cordell Jun. 21, 1992 Specification Column 3 Line 17 to Line 29

2. Example of web of steel cables used in U.S. Pat. No. 5,146,045 “Underwater Mine” granted to Steve Cordell Sep. 8, 1992 Drawing Sheet 7 of 8 FIG. 7

3. Examples of heavy-duty curtains, without and with Neoprene layers:
US Naval Institute Proceedings Nov. 2008 P. 74-76 Steve Cordell “Soft-Kill Capture of the Supercavitating Torpedo”
US Naval Institute Proceedings Dec. 2009 P. 81-82 Steve Cordell “Submarine Self-Escape at 2,000 Feet”

What is claimed is:

1. A method for completely sealing or by choice partially sealing any type of spill, leak, gusher, or outflowing of gas, mud, petroleum, finely divided solids or any other fluids either underwater, especially on the seabed, or on, under or above ground, and a method of transferring or collecting products of said leak, spill, gusher or outflowing comprising the steps of:
selecting from stock, or creating a weighted, preferably circular-shaped curtain containing one or more redirecting valves with built-in flanges, or by attaching the valves to the curtain with flanges or by using other standard, well-known methods of attachment such as heat-welding, said curtain having a shape to fit on top of the spill including its immediate surroundings, and
placing the curtain over the spill area, so that when pouring cement of a type appropriate to the task over the curtain, the cement remains caught behind the curtain's periphery-weighted, upward-bulging roll of weights, thereby forcing by gravity the curtain ever tighter over the spill area, tending to increase the weight on the weighted curtain and consequently restricting the spill product, and
fitting to the built-in redirection valves pipes or tubes and beginning the transfer of some product of the source, and
without fitting transfer pipes or tubes to the valves, adding optionally a second curtain over the first curtain having a larger diameter than the first, having through-channels with stopcock functions instead of valves, each of which having the approximate position on its curtain as its mating valve on the first curtain, and
connecting the first curtain's redirection valves with the second curtain's through-channels, and
filling the second curtain with cement in the same manner as filling the first curtain, and
fitting to the top curtain's through-channels pipes or tubes and thus beginning the transfer of spill product of the source.

2. A method for completely sealing or by choice partially sealing any type of spill, leak, gusher, or outflowing of gas, mud, petroleum, finely divided solids or any other fluids either underwater, especially on the seabed, or on, under or above ground, and a method of transferring or collecting products of said leak, spill, gusher or outflowing comprising the steps of:
creating a large curtain made of ultra-strong materials such as Kevlar and titanium weave, adding to this weave thin or thick Neoprene or similar heavy duty plastic having similar waterproof characteristics, the weaving layers being as numerous and having a layer arrangement as dictated by the outflow volume and pressure and the environment near the leak, and
said curtain having the preferred shape and circular form of a contraceptive diaphragm with the advantages of handling ease and reliability, or by using other similar shapes and forms for the curtain, and
placing the central lifting ring for transportation in the center of the curtain and fastening the lifting ring with flanges, and
said curtain being prepared for weight wrapping on the curtain's periphery by slicing sections from an oversized curtain, weighting the curtain's outer circumference by rolling the cylinder-shaped lead or similar weights slightly toward the curtain's center while wrapping all of a sliced section around the corresponding weight such that the curtain's rim takes the form of a tire on the outer periphery after all weights have been wrapped in this manner, and
binding the weights to ensure that the individual weights remain permanently in position, and
one or more redirecting valves are applied to the curtain by attaching the valves to the curtain with flanges or by using other standard well-known methods of attachment such as heat-welding, and
laying the completed curtain over the underwater or above-ground leak, as the case may be, and minimizing any initial curtain fluttering optionally by roughly anchoring the curtain with a self-expanding apparatus and tethering cables to be anchored outside of the prepared ring, and by rapidly filling one side with cement and then continuing pouring cement around the circumference as well as pouring cement toward the curtain's center until the complete periphery and the center of the curtain have achieved a sufficient weight to completely seal the leak with no fluttering and there exists merely an amount of leakage that is considered acceptable.

3. The method as specified in claim 1, whereby, depending on the immediate environment of the leak, preparation for laying the curtain may require none, some or all of the steps of smoothing a circular path and removing obstacles in the path so the peripheral weights will have a more optimum sealing surface, and
removing, repositioning or modifying the attitude of any sharp objects such as rocks, or reducing the length of a wellpipe or by modifying the wellpipe ending to eliminate the cause of possible cuts or cracks to the curtain and leakage through the curtain when it is partially or fully weighted, and
attaching to the curtain's underside a self-expanding apparatus, thus modifying the surface around the leak to reduce the risk of curtain damage or wellpipe damage.
